(19) United States
(12) Patent Application Publication
(10) Pub. No.: US 2021/0267236 A1
(43) Pub. Date: Sep. 2, 2021

(54) FERMENTED SPARKLING VINEGAR BEVERAGE AND PREPARING METHOD THEREOF

(71) Applicant: YUAN SHENG YANG SHENG CO., LTD., Kaohsiung City (TW)

(72) Inventors: TIENFA HSU, Kaohsiung City (TW); JUIYU CHOU, Kaohsiung City (TW); SHIHAN HSU, Kaohsiung City (TW)

(21) Appl. No.: 17/258,412

(22) PCT Filed: Jul. 9, 2018
(86) PCT No.: PCT/CN2018/094984

§ 371 Date: Jan. 6, 2021

(51) Int. Cl. A23L 2/38; C12J 1/00; A23L 2/04; A23L 33/14; A23L 33/125

(52) U.S. Cl. CPC A23L 2/382; C12J 1/00; C12R 2001/865; A23L 33/14; A23L 33/125; A23L 2/04

(57) ABSTRACT

A fermented sparkling vinegar beverage includes a fermented solution formed of 0 vol % of to 15 vol % of raw vinegar, 3 vol % of to 15 vol % of sugar, 0 vol % of to 5 vol % of honey, 0 vol % of to 0.3 vol % of salt, 0 vol % of to 40 vol % of plant extracts, 1 vol % of to 5 vol % of yeast liquid, and water. Composition of yeast liquid varies according to different product flavors; yeast strains are selected from Saccharomyces cerevisiae, Hanseniaspora osmophila, Hanseniaspora valbyensis, Torulaspora delbrueckii, and Dekkera bruxellensis in different ratios, and the yeast strains generate metabolite and produce bubbles in the fermented solution. Therefore, the present invention brews the fermented solution by yeast liquid formed of various yeasts, applying the metabolites and bubbles generated through fermentation of the yeast strains to alleviate sour content of the raw vinegar, so as to improve the drinking taste of the fermented solution.

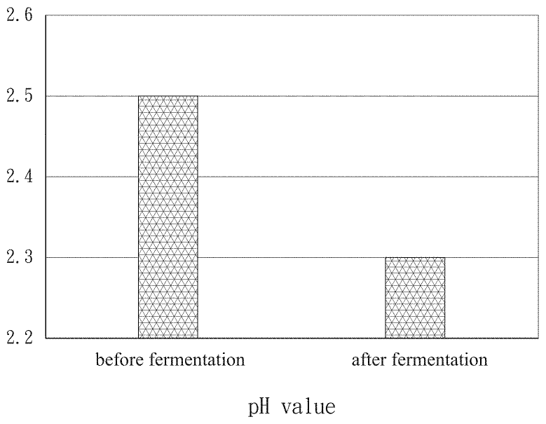

### BACKGROUND OF THE INVENTION

### 1. Field of the Invention

The present invention relates to vinegar beverage field, and more particularly, to a fermented sparkling vinegar beverage and preparing method thereof.

### 2. Description of the Related Art

According to the rise of health awareness of consumer, vinegar beverages on the market acquire much attention, and vinegar beverages are mainly divided into brewed vinegar beverages and synthetic vinegar drinks.

Brewed vinegar beverages use grains, fruits, alcohol and other materials as raw materials, with acetic acid bacteria added for fermentation. Naturally brewed vinegar beverages have different flavors and nutritional values based on the types of the raw materials.

Synthetic vinegar beverages use glacial acetic acid as the main raw material, wherein the glacial acetic acid is diluted and added with amino acids, organic acids, fruit juices, seasonings, spices, pigments, and other auxiliary materials for mixture fermentation. The production time of synthetic vinegar beverages is short, and it has a pungent choking vinegar smell. Also, the drinking quality of synthetic vinegar beverages is less smooth compared with that of brewed vinegar beverages, so it is mainly used for food flavoring.

Therein, brewed vinegar beverages contain flavors and nutrition value from natural materials. As disclosed by published China patent CN101283825A, a tomato vinegar drink and manufacturing method thereof, tomatoes are used as natural material for brewing, so as to prepare the tomato vinegar drink which has special aroma of tomatoes.

However, aforementioned naturally brewed tomato vinegar has following shortcomings:
(1) Naturally brewed tomato vinegar has overly acidic or pungent taste, so it is unable to drink the fruit vinegar smoothly, causing the reduction of consumer's willingness to drink the fruit vinegar.
(2) The tomato vinegar undergoes a high-temperature sterilizing process before leaving the factory, whereby the nutrition value in the vinegar is damaged by the high temperature, lowering the nutrition value of the vinegar.

### SUMMARY OF THE INVENTION

To improve the shortcomings above, the present invention provides a fermented sparkling vinegar beverage and preparing method thereof, which applies the metabolites and bubbles produced by the fermentation of yeast liquid containing a variety of yeasts to alleviate the sour contents of the raw vinegar, so as to improve the taste of drinking fermented solution.

For achieving the aforementioned objectives, the present invention provides a fermented sparkling vinegar beverage, comprising a fermented solution formed of 0 vol % of to 15 vol % of raw vinegar, 3 vol % of to 15 vol % of sugar, 0 vol % of to 5 vol % of honey, 0 vol % of to 0.3 vol % of salt, 0 vol % of to 40 vol % of plant extracts, 1 vol % of to 5 vol % of yeast liquid, and water. The yeast strains of the yeast liquid are selected from a group consisting of Saccharomyces cerevisiae, Hanseniaspora osmophila, Hanseniaspora valbyensis, Torulaspora delbrueckii, and Dekkera bruxellensis, and the yeast strains generate a metabolite and produces bubbles in the fermented solution.

Another embodiment of the present invention provides a preparing method of a fermented sparkling vinegar beverage, comprising a primary fermentation and a secondary fermentation steps. In the primary fermentation step, plurality of natural materials and sugar are added in a naturally brewed vinegar, which is then placed in a maturing temperature environment, so as to carry out a seal fermentation for a first maturing time to form a raw vinegar. In the secondary fermentation step, the fermented raw vinegar is taken out, and the raw vinegar, sugar, honey, salt, plant extracts, yeast liquid, and water are mixed in a pressure resistant container, which is then placed in the maturing temperature environment again, so as to carry out a secondary fermentation for a second maturing time, wherein the yeast strains of the yeast liquid are selected from a group consisting of Saccharomyces cerevisiae, Hanseniaspora osmophila, Hanseniaspora valbyensis, Torulaspora delbrueckii, and Dekkera bruxellensis, and the yeast strains generate a metabolite and produces bubbles in the fermented solution through the fermentation, thereby alleviating the sour content of the raw vinegar.

Therefore, the present invention carries out a fermentation through the yeast liquid containing a variety of yeasts for brewing the fermented solution, and uses the metabolites and bubbles generated through the fermentation of the yeast strains to alleviate the sour content of the raw vinegar, thereby improving the taste of the fermented solution.

### BRIEF DESCRIPTION OF THE DRAWINGS

The sole FIGURE is a statistical diagram of pH value test the fermented solution before and after the fermentation in accordance with the present invention.

### DETAILED DESCRIPTION OF THE INVENTION

In order to facilitate the description of the central idea of the present invention presented in the column of the abovementioned summary of the invention, specific examples are used for expression.

The present invention provides a fermented sparkling vinegar beverage which comprises a fermented solution containing 0 vol % of to 15 vol % of raw vinegar, 3 vol % of to 15 vol % of sugar, 0 vol % of to 5 vol % of honey, 0 vol % of to 0.3 vol % of salt, 0 vol % of to 40 vol % of plant extracts, 1 vol % of to 5 vol % of yeast liquid, and water. Therein, the yeast liquid comprises a plurality of yeast strains, and the composition of yeast strains changes according to the flavor of the product. The yeast strains of the yeast liquid are selected from a group consisting of Saccharomyces cerevisiae, Hanseniaspora osmophila, Hanseniaspora valbyensis, Torulaspora delbrueckii, and Dekkera bruxellensis in different ratios. However, the yeast strains in the present invention are not limited thereto. The yeast strains generate a metabolite and produces bubbles in the fermented solution through the fermentation

Specifically, the preparing method of the fermented sparkling vinegar beverages of the present invention comprises following steps:

Primary fermentation: a plurality of natural materials and sugar are added into a naturally brewed vinegar, which is then placed in an environment of a maturing temperature, so as to be sealed and fermented for a first maturing time to form a raw vinegar, wherein the flavor and aroma of the raw vinegar come from the product from the fermentation of natural materials. In the embodiment, the natural materials are selected from fruits and plants undergoing extraction and homogenize juicing, and the extraction method of each natural material is different; for example, if pineapples or passion fruits are chosen as the natural material of the raw vinegar, the pulp and juice of the pineapples and passion fruits are acquired through homogenize juicing for the brewing fermentation; if lemons, ginsengs, or sweet osmanthus are chosen as the natural material of the raw vinegar, the vinegar can be extracted through brewing; if oranges or tomatoes are chosen as the natural material of the raw vinegar, the pulp and juice of the oranges or tomatoes are further acquired through extraction and homogenize juicing at the same time for the brewing fermentation; if mulberries are chosen as the natural material of the raw vinegar, mulberry juice concentrate can be directly used for the brewing fermentation.

Notably, in the raw vinegar, the concentration of the naturally brewed vinegar in the raw vinegar is 29 vol % of to 47 vol % of, the concentration of the natural material is 3 vol % of to 57 vol % of, the concentration of the sugar is 0 vol % of to 14 vol % of, with water added. The brewing process is carried out in an environment with a maturing temperature between 20 to 30 Celsius degrees for a first maturing time of 2 months to 3 years, whereby the naturally brewed vinegar and the natural materials are sealed to mature.

Secondary fermentation: the fermented raw vinegar is filtered out, then the raw vinegar is placed into a pressure resistant container with sugar, honey, salt, plant extracts, yeast liquid, and water, and the mixture is again placed in the maturing environment with the maturing temperature between 20 to 30 Celsius degrees for a second maturing time for secondary fermentation to form a fermented solution, wherein the second maturing time is 2 to 8 days, and the fermented solution does not undergo a sterilizing process after the second maturing time, so as to keep the active yeast strains of the yeast liquid. Notably, a portion of the raw vinegar does not have sufficient flavor after the primary fermentation. Thus, for increasing the drinking flavor of the raw vinegar, the present invention will add plant extracts again in the secondary fermentation step for flavor maturation and adjustment.

Notably, in the yeast liquid, the Saccharomyces cerevisiae is also called beer yeast, which ferments to produce alcohol and carbon dioxide and is the most commonly used yeast for brewing; The Saccharomyces cerevisiae and Hanseniaspora osmophila are the types mainly applied in initial state of the brewing industry, and they can produce esters product for enhancing the aroma of wine; the Torulaspora delbrueckii has the character of better fermentation ability and aroma, and is mainly applied in various fermented food products and grape wine brewing; the Dekkera bruxellensis belongs to Brettanomyces, and the Dekkera bruxellensis is a brewing yeast, which is often applied in beer brewing and able to produce attractive aroma through fermentation.

For further illustration, during the fermentation of the yeast liquid, the brewing yeast produces carbon dioxide in the fermentation solution. So that when the fermentation solution is sealed and the yeast keeps producing carbon dioxide, the internal pressure of the pressure resistant container increases. When the pressure resistant container is opened, due to the decreasing pressure, large bulk of carbon dioxide is separated from the fermentation solution, so that the fermentation solution forms a large amount of bubbles. In addition, during the fermentation, the Saccharomyces cerevisiae, Hanseniaspora osmophila, Hanseniaspora valbyensis, Torulaspora delbrueckii, and Dekkera bruxellensis in the yeast liquid simultaneously produces a variety of organic acids and esters, and such fermentation metabolites greatly vary the flavor of the raw vinegar, thereby improving the effect of the pungent acidic taste of the fermentation solution. Further, the fermentation liquid preserves the plurality kinds of yeast strains of the yeast liquid, so that after fermentation being consumed, the activity of the yeast strains improve gastrointestinal operation in the body, thereby enhancing the gastrointestinal digestion. The types of yeast strains above are only taken as the embodiment of the present invention and not limited thereto.

In the present invention, during the secondary fermentation step, the cell count of the yeast liquid is 1.28*10⁶ cell count /milliliter. Particularly, the yeast liquid is prepared by inoculating a yeast culture fluid with the aforementioned Saccharomyces cerevisiae, Hanseniaspora osmophila, Hanseniaspora valbyensis, Torulaspora delbrueckii, and Dekkera bruxellensis, respectively, and the fluid is cultured for 1 day in a 28 Celsius degrees environment, and then moved to a refrigerator for cold storage with 4 Celsius degrees. Therein, the yeast culture fluid is a mixture with crystal sugar and golden sugar in a ratio of 2:1 and accounting for 5 to 10% of the total weight. Then, the cultured yeast liquid is measured for light absorbance thereof with OD660 through a spectrophotometer. By comparison with a preset standard curve, the cell count thereof is calculated according to the turbidity of the yeast liquid, and then diluted with clean culture fluid to the cell count needed for preparing the vinegar beverage.

In an embodiment of the present invention, pH value of the fermented solution is measured as ranging from 1.5 to 4.5, and the Brix of the fermented solution is measured as ranging from 3.5 to 7.5. Notably, the pH value of the fermented solution will change according to the types of the natural materials in the raw vinegar and the combination of yeast strains in the yeast liquid. Brix is a measuring unit of sugar, representing the grams of sucrose soluble in 100 grams of solution when in a temperature of 20 Celsius degrees. Brix will change according to the sugar content of the natural materials in the raw vinegar, the addition amount of sugar and honey, and the addition amount of the plant extracts.

### Variation of pH Value

The present invention applies 35 g of lemon raw vinegar, 22 g of sugar, 6.3 g of honey, 0.24 g of salt, 5 ml of yeast liquid, and 432 ml of water, and the fermentation is carried out in a 20 to 30 Celsius degrees environment for 2 to 3 days, thereby forming a lemon flavored fermented solution.

The measurement measures and calculates the pH value difference of the lemon raw vinegar before and after the secondary fermentation step. The measurement result is shown by the sole FIGURE. Before the secondary fermentation step, the average pH value of the lemon raw vinegar is 2.5; relatively, after the secondary fermentation step, the average pH value of the lemon raw vinegar lowers to 2.3.

### Sensory Evaluation Questionnaire Survey

This questionnaire survey was conducted by more than 30 subjects (adults) who drank the lemon, mulberry, pineapple, plum and roselle flavored fermented solutions in accordance with the embodiment, and then received a questionnaire survey on the acceptance of sensory characteristics. As shown by results of 30 valid questionnaires, the acceptance of subjects concerning the appearance, aroma, color, taste, and flavor are all great in average, indicating that the fermented solutions of various flavors prepared according to the embodiment are acceptable by the public.

It should be added that although the present invention uses a specific preparing process, a specific analytical method or a specific instrument as the embodiment for illustrating the fermented sparkling vinegar beverage and the preparation method of the present invention, anyone in the technical field of the present invention having general knowledge can understand that the present invention is not limited hereto, and, without departing from the spirit and scope of the present invention, the fermented sparkling vinegar beverage and the preparing method thereof can also be carried out using other manufacturing processes, analytical methods, or instruments.

Accordingly, the present invention is disclosed by several embodiments as above, but it is not intended to limit the present invention. Anyone with ordinary knowledge in the technical field of the present invention, without departing from the spirit and scope of the present invention, can conduct various changes and modifications, so that the protection scope of the present invention shall be subject to the scope of the attached claims.

What is claimed is:

1. A fermented sparkling vinegar beverage, comprising:
a fermented solution formed of 0 vol % of to 15 vol % of raw vinegar, 3 vol % of to 15 vol % of sugar, 0 vol % of to 5 vol % of honey, 0 vol % of to 0.3 vol % of salt, 0 vol % of to 40 vol % of plant extracts, 1 vol % of to 5 vol % of yeast liquid, and water, yeast strains of the yeast liquid being selected from a group consisting of Saccharomyces cerevisiae, Hanseniaspora osmophila, Hanseniaspora valbyensis, Torulaspora delbrueckii, and Dekkera bruxellensis, and the yeast strains generating a metabolite and producing bubbles in the fermented solution.

2. The fermented sparkling vinegar beverage of claim 1, wherein the raw vinegar comprises a plurality of natural materials; the natural materials are selected from fruits and plants, and acquired through extraction and homogenize juicing.

3. The fermented sparkling vinegar beverage of claim 1, wherein a pH value of the fermented solution is measured as ranging from 1.5 to 4.5.

4. The fermented sparkling vinegar beverage of claim 1, wherein a Brix of the fermented solution is measured as ranging from 3.5 to 7.5.

5. The fermented sparkling vinegar beverage of claim 1, wherein the bubbles produced by the yeast strains are carbon dioxide.

6. A preparing method of a fermented sparkling vinegar beverage, comprising following steps:
primary fermentation: a plurality of natural materials and sugar are added into a naturally brewed vinegar, which is then placed in an environment of a maturing temperature, so as to be sealed and fermented for a first maturing time to form a raw vinegar; and
secondary fermentation: the fermented raw vinegar is filtered out, and the raw vinegar is mixed with sugar, honey, salt, plant extracts, yeast liquid, and water in a pressure resistant container, which is then placed in the environment of the maturing temperature again, so as to carry out a secondary fermentation for a second maturing time, wherein the yeast strains of the yeast liquid are selected from a group consisting of Saccharomyces cerevisiae, Hanseniaspora osmophila, Hanseniaspora valbyensis, Torulaspora delbrueckii, and Dekkera bruxellensis, whereby the yeast strains generate a metabolite and produces bubbles in the fermented solution through fermentation, thereby alleviating a sour content of the raw vinegar.

7. The preparing method of a fermented sparkling vinegar beverage of claim 6, wherein during the primary fermentation step, the natural materials are selected from fruits and plants, and acquired through extraction and homogenize juicing.

8. The preparing method of a fermented sparkling vinegar beverage of claim 6, wherein the maturing temperature ranged between 20 to 30 Celsius degrees, the first maturing time ranges from 2 months to 3 years, and the second maturing time ranges from 2 days to 8 days.

9. The preparing method of a fermented sparkling vinegar beverage of claim 6, wherein during the secondary fermentation step, a pH value of the fermented solution is measured as ranging from 1.5 to 4.5.

10. The preparing method of a fermented sparkling vinegar beverage of claim 6, wherein during the secondary fermentation step, a Brix of the fermented solution is measured as ranging from 3.5 to 7.5.
